(19) United States
(12) Patent Application Publication
(10) Pub. No.: US 2008/0317945 A1
(43) Pub. Date: Dec. 25, 2008

(54) ELECTROLYTE MEMBRANES FOR USE IN FUEL CELLS

(75) Inventors: Daishi YOSHIKAWA, Nagoya (JP); Balagopal N. Nair, Nagoya (JP)

Correspondence Address: OLIFF & BERRIDGE, PLC, P.O. BOX 320850, ALEXANDRIA, VA, 22320-4850, US

(73) Assignee: NORITAKE CO., LIMITED, Nagoya (JP)

(21) Appl. No.: 12/045,452

(22) Filed: Mar. 10, 2008

Related U.S. Application Data
(62) Division of application No. 10/646,686, filed on Aug. 25, 2003, now abandoned.

(30) Foreign Application Priority Data
Sep. 5, 2002 (JP) 2002-260485

(51) Int. Cl. H01M 8/10

(52) U.S. Cl. 427/115; 429/30

(57) ABSTRACT

A solid polymer electrolyte membrane that has excellent methanol-crossover-suppression performance is provided, along with a fuel cell that employs the electrolyte membrane. The electrolyte membrane includes a matrix including a proton-conducting polymer such as perfluorocarbon sulfonic acid and a sheet substantially consisting of an inorganic fiber such as glass fiber.

### CROSS-REFERENCE TO RELATED APPLICATION

This application is a divisional application of U.S. patent application Ser. No. 10/646,686 filed Aug. 25, 2003, incorporated herein by reference in its entirety. This application also claims priority to Japanese Patent Application No. 2002-260485, filed Sep. 5, 2002, the contents of which are incorporated herein by reference.

### BACKGROUND

1. Field

The invention relates to an electrolyte membrane used in a polymer electrolyte fuel cell (PEFC), a class of fuel cell that includes direct methanol fuel cells (DMFCs). The invention also relates to fuel cells comprising such an electrolyte membrane.

2. Description of the Related Art

As is schematically illustrated in FIG. 8, a fuel cell generally comprises a negative electrode (anode) 112 located on the side of a fuel chamber 111, a positive electrode (cathode) 114 located on the side of an oxidation gas chamber 115, and an electrolyte 113 sandwiched between the electrodes 112, 114. Polymer electrolyte fuel cells (PEFCs) normally employ a proton-conducting solid polymer electrolyte membrane as the electrolyte 113. An example of an electrolyte material typically used to constitute the membrane is Nafion® membrane, a perfluorinated ion-exchange resin obtainable from the DuPont Chemical Company.

As FIG. 8 illustrates, a typical fuel cell generates electricity by supplying hydrogen as a fuel to the anode 112. But in direct methanol fuel cells (DMFCs), methanol is directly supplied to the anode 112 (not hydrogen or another substance obtained by reforming methanol). Consequently, the use of a DMFC eliminates the need for a reformer for generating hydrogen from a hydrocarbon gas or a liquid fuel and allows a simple generation system to be configured. One problem with DMFC systems is that methanol permeates the electrolyte membrane 113, or in other words, methanol crossover occurs. Methanol passing through the membrane is directly oxidized at the cathode 114, lowering the electromotive force of the cell and fuel use efficiency, and is therefore undesirable. Development is therefore underway on electrolyte membranes capable of suppressing methanol permeation (crossover) more effectively than conventional electrolyte membranes.

For example, the pamphlet of International Patent Application Publication WO00/54351 discusses an electrolyte membrane comprising a porous base that does not substantially swell in the presence of methanol or water, and a proton-conducting polymer that fills the pores of the base. Also, Japanese Unexamined Patent Application Publication No. 11-135137 discusses a DMFC that employs an anion exchange membrane that is an anion exchange material supported on a porous membrane comprising a polyolefin or polyfluoroolefin. Finally, U.S. Pat. No. 6,444,343 discusses a polymer electrolyte membrane comprising polystyrene sulfonic acid (PSSA) cross linked with polyvinylidene fluoride (PVDF).

### SUMMARY

An objective of the invention is to provide an electrolyte membrane of a novel configuration that has excellent methanol-crossover-suppression performance. Another object of the invention is to offer a fuel cell that comprises such an electrolyte membrane. Another related object is to offer a solid polymer electrolyte membrane applicable as a constituting element of a direct methanol fuel cell. The invention also provides a method for suppressing methanol crossover that employs such an electrolyte membrane.

The electrolyte membrane disclosed herein comprises a matrix composed mainly of a proton-conducting polymer and a sheet substantially composed of an inorganic fiber. Preferably, at least one portion of the sheet penetrates (is embedded in) a proton-conducting polymer matrix. Typically, the sheet is formed by assembling a plurality of inorganic fibers in a sheet-like configuration. According to the configuration of the electrolyte membrane of the invention, the movement of the polymer chain constituting the proton-conducting polymer matrix can be suppressed by interweaving of the inorganic fiber constituting the sheet. For example, swelling of the proton-conducting polymer matrix when the electrolyte membrane makes contact with a fuel (typically methanol) is suppressed in comparison to a configuration in which the sheet does not penetrate. The suppression of swelling in this manner makes it more difficult for methanol or another fuel to permeate the polymer matrix (electrolyte membrane).

In a preferred embodiment, almost the entire sheet is embedded in the proton-conducting polymer matrix. With the construction of this embodiment, the proton-conducting polymer matrix is exposed on one surface and the other surface of the electrolyte membrane, so a satisfactory state of contact can be easily achieved between the electrolyte membrane and other components that constitute the cell (typically, the electrodes). The internal resistance of the cell can thus be reduced.

A preferred example of the inorganic fiber constituting the sheet is glass fiber. Non-woven cloth and woven cloth made primarily of glass fiber (e.g., glass cloth) are widely commercially available and easily obtainable. Sheets made by cutting these to an appropriate size according to necessity can be suitably used. In addition, sheets composed primarily of glass fiber are easy to handle.

In addition, the invention provides a fuel cell comprising an anode, a cathode, and an electrolyte membrane disposed between these electrodes. This fuel cell element, as was discussed earlier, comprises an electrolyte membrane capable of suppressing methanol crossover and as such is suited for use as a fuel cell in which methanol is directly supplied to the anode (i.e., a direct methanol fuel cell). Preferably, the anode comprises a catalyst capable of generating hydrogen from methanol (e.g., a platinum-ruthenium catalyst). It should be noted that the fuel cell element disclosed herein is obviously also suited for use in constructing a fuel cell in which a fuel other than methanol (typically, hydrogen) is supplied to the anode.

Moreover, the use of the electrolyte membrane disclosed herein as an electrolyte membrane positioned between the anode and cathode of a direct methanol fuel cell constitutes a method for suppressing methanol crossover in fuel cells in which methanol is supplied as a fuel.

### BRIEF DESCRIPTION OF THE DRAWINGS

FIG. 1 is a schematic diagram showing one embodiment of the direct methanol fuel cell provided by the invention.

FIG. 2 is a scanning electron micrograph showing the surface of the electrolyte membrane of one working example.

FIG. 3 is a scanning electron micrograph showing a cross section of the electrolyte membrane of one working example.

FIG. 4 is a graph illustrating the plot of power density vs. voltage in a fuel cell made with the electrolyte membrane of Working Example 1 and a fuel cell made with the electrolyte membrane of Comparative Example 1 (fuel: methanol; operating temperature: 95° C.).

FIG. 5 is a graph illustrating the plot of power density vs. voltage in a fuel cell made with the electrolyte membrane of Working Example 1 and a fuel cell made with the electrolyte membrane of Comparative Example 1 (fuel: methanol; operating temperature: 120° C.).

FIG. 6 is a graph illustrating the plot of power density vs. voltage in a fuel cell made with the electrolyte membrane of Working Example 1 and a fuel cell made with the electrolyte membrane of Comparative Example 1 (fuel: hydrogen; operating temperature: 80° C.).

FIG. 7 is a graph illustrating the plot of power density vs. voltage in a fuel cell made with the electrolyte membrane of Working Example 1 and a fuel cell made with the electrolyte membrane of Comparative Example 1 (fuel: hydrogen; operating temperature: 120° C.).

FIG. 8 is a schematic diagram showing the overall configuration of a general fuel cell.

FIG. 9 is a graph illustrating the plot of power density vs. voltage in a fuel cell made with the electrolyte membrane of Working Example 2 (fuel: methanol; operating temperature: 95° C.).

FIG. 10 is a graph illustrating the plot of power density vs. voltage in a fuel cell made with the electrolyte membrane of Comparative Example 3 (fuel: methanol; operating temperature: 95° C.).

FIG. 11 is a graph illustrating the plot of power density vs. voltage in a fuel cell made with the electrolyte membrane of Comparative Example 4 (fuel: methanol; operating temperature: 95° C.).

FIG. 12 is a graph illustrating the plot of power density vs. voltage in a fuel cell made with the electrolyte membrane of Comparative Example 5 (fuel: methanol; operating temperature: 95° C.).

FIG. 13 is a graph illustrating the plot of power density vs. voltage in a fuel cell made with the electrolyte membrane of Working Example 2 (fuel: hydrogen; operating temperature: 80° C.).

FIG. 14 is a graph illustrating the plot of power density vs. voltage in a fuel cell made with the electrolyte membrane of Comparative Example 3 (fuel: hydrogen; operating temperature: 80° C.).

FIG. 15 is a graph illustrating the plot of power density vs. voltage in a fuel cell made with the electrolyte membrane of Comparative Example 4 (fuel: hydrogen; operating temperature: 80° C.).

FIG. 16 is a graph illustrating the plot of power density vs. voltage in a fuel cell made with the electrolyte membrane of Comparative Example 5 (fuel: hydrogen; operating temperature: 80° C.).

### DETAILED DESCRIPTION OF EMBODIMENTS

Hereafter, preferred embodiments of the invention will be discussed. It should be noted that matters other than those items mentioned specifically in the Specification that are necessary for the implementation of the invention can be understood as design-related items by those skilled in the art based on the prior art. The invention can be implemented based on the items disclosed in the Specification and common technical knowledge in applicable fields.

A polymer of the same type as a polymer constituting conventional electrolyte membranes that employ PEFC can be used as the proton-conducting polymer that constitutes the matrix of the electrolyte membrane taught herein.

For example, various types of polymers with proton conductivity (proton-conducting polymers) can be used, such as a homopolymer derived from a monomer with an ion-exchange group (e.g., an SO₃H group) or a copolymer derived from such monomers, a copolymer derived from monomers comprising at least one monomer having an ion-exchange group and another monomer or monomers capable of copolymerizing with the monomer, or a polymer obtained by after-treating with an appropriate after-treatment method (e.g., hydrolysis) to a homopolymer derived from a monomer with a functional group that can be transferred into an ion-exchange group through after-treatment such as hydrolysis (i.e., an ion-exchange group precursor) or a copolymer derived from monomers comprising such monomer (a proton-conducting polymer precursor).

Alternatively, a material can be used that is conferred with proton conductivity through the introduction of an ion-exchange group after a matrix is formed using a polymer lacking an ion exchange group or a precursor thereof (functional group) or having a small content thereof (i.e., after formation into a membrane-like shape).

Typical examples of the proton-conducting polymer constituting the electrolyte membrane of the invention are peperfluorinated proton-conducting polymers (typically, a perfluorocarbon sulfonic acid resin). Other examples of preferable proton-conducting polymers are perfluorocarbon carboxylic acid resins, sulfonic acid-type styrene-graft-ethylene tetrafluoroethylene (ETFE) copolymers, sulfonic acid-type poly(trifluorostyrene)-graft-ETFE copolymers, and polyether ether ketone (PEEK) sulfonic acid.

There are no particular limits as to the thickness of the membrane comprising the proton-conducting polymer matrix. A range of about 5 to 500 μm, for example, is possible. The range is preferably set to about 10 to 300 μm. If the polymer matrix is too thick, internal resistance increases, which sometimes results in a drop in performance as a cell and is therefore undesirable. If the polymer matrix is too thin, on the other hand, the rate of permeation of the fuel (for instance, methanol crossover when used as a DMFC) can rise and is therefore undesirable.

Since the electrolyte membrane of the invention performs excellently in preventing the passage of methanol and other fuels, it can be preferably used in a PEFC (particularly, a DMFC) even with a thickness of, for example, about 5 to 100 μm (preferably a thickness of about 10 to 80 μm and more preferably of about 15 to 60 μm).

And examples of the inorganic fiber that constitutes the sheet are glass fiber, carbon fiber, alumina fiber, silicon carbide fiber, silica fiber or another ceramic fiber, magnesium oxysulfate whisker, potassium titanate whisker, and aluminum borate whisker. Of these inorganic fibers, glass fiber can be particularly preferably used. A woven cloth or non-woven cloth made by forming these inorganic fibers into a sheet is desirable. Woven cloth can be woven with a weave such as plain weave, twill weave, satin weave, or leno weave. The cloth can be one in which the individual inorganic fibers are directly woven or one in which the inorganic fibers are bundled and the resulting threads (e.g., glass yarns (glass threads)) are woven. The sheet can be a combination of two or more types of inorganic fiber.

An example of one preferable sheet is a glass cloth of woven glass yarn (typically, plain woven). The fiber width of the glass yarn constituting such a glass cloth, when the sheet is viewed from thickness direction, is preferably in the range of about 5 to 300 μm and more preferably in the range of about 10 to 150 μm. The opening in the glass cloth is preferably in the range of about 10 to 500 μm and more preferably in the range of about 20 to 300 μm.

The thickness of the sheet is appropriately set at approximately 1.5 times or less (typically approximately 0.1 to 1.5 times) the thickness of the membrane comprising the proton-conducting polymer matrix, and it is desirable to set it at approximately 1 time or less (typically, approximately 0.2 to 1 time) and more desirable to set it as approximately 0.8 times or less (typically, approximately 0.3 to 0.8 times). A sheet with a thickness of about 10 to 50 μm, for example, can be used, and a sheet with a thickness of about 20 to 30 μm is preferably used. The porosity of the sheet can be set in a range, for example, of about 5 to 95% by volume, and a preferable range is about 10 to 90% by volume. If the porosity is too high, the effect of suppressing the permeation of methanol or another such fuel is diminished and as such is undesirable. If the porosity is too low, on the other hand, the internal resistance of the cell readily rises and is therefore undesirable.

There are no particular limits on the fiber diameter or the fiber length of the inorganic fibers constituting the sheet. For example, an inorganic fiber with a mean fiber diameter in the range of about 0.1 to 30 μm (preferably about 1 to 20 μm) can be used. And an inorganic fiber with a mean fiber length of about 1 to 100 mm (preferably about 5 to 50 mm) can be used.

A surface treatment such as treatment with a silane-coupling agent can be applied to the sheet. Such treatment can improve adherence to the proton-conducting polymer matrix. And on the occasion when an electrolyte membrane is to be prepared, the proton-conducting polymer matrix can be made to spread through the openings (holes) of the sheet.

Typically, the electrolyte membrane disclosed herein comprising the sheet which is disposed with at least part of the thickness of the sheet implanted (lodged) in the proton-conducting polymer matrix. At least 30% of the sheet thickness is preferably embedded in the proton-conducting polymer matrix (polymer membrane), more preferably, at least approximately 50% of the sheet thickness is embedded, and yet more preferably, at least approximately 80% of the sheet thickness is embedded. It is particularly preferable that substantially the whole of the sheet is embedded in the polymer matrix.

The percentage of the thickness of the portion in which the inorganic fiber sheet is embedded to the entire thickness of the polymer matrix (polymer membrane) is preferably approximately 10% to 100%, more preferably approximately 20% to 90%, and even more preferably approximately 30% to 80%. It is preferable that substantially no openings (i.e., the portion that the polymer matrix does not fill) are present in the portion of the sheet lodged in the proton-conducting polymer matrix.

The sheet preferably is disposed across almost the whole area of the electrolyte membrane, but it is acceptable if the sheet is not situated on a portion of the electrolyte membrane. For example, the sheet can be embedded in the center portion of the electrolyte membrane (i.e., the portion other than the edges of the electrolyte membrane). Of the entire area of the electrolyte membrane, the area of the portion that the sheet is situated on is preferably at least approximately 50%, more preferably at least approximately 70%, and even more preferably at least approximately 85%. In addition, two or more sheets can be situated on a single electrolyte membrane. These sheets can be made to overlap partly or almost entirety and be disposed on the inside or surface portion of the electrolyte membrane. Alternatively, the sheets can be aligned with spacing or neighboring so that substantially no mutually overlapping portion results on the inside or surface portion of the electrolyte membrane.

The entire thickness of the electrolyte membrane can, for example be in the range of about 5 to 500 μm and is normally preferably in the range of about 10 to 300 μm. When the entire thickness of the electrolyte membrane is relatively thin, even if it is, for example, in the range of about 5 to 100 μm (preferably about 10 to 80 μm and more preferably about 15 to 60 μm), the permeation of fuel (typically, methanol crossover) is well prevented. It is preferable that at least one surface of the electrolyte membrane and preferably both surfaces are formed substantially from the proton-conducting polymer matrix (i.e., the inorganic fiber is not exposed on that surface or those surfaces). When this is the case, excellent contact between the anode and/or cathode and the electrolyte membrane in an assembled fuel cell is easily achieved.

The electrolyte membrane of the invention is suitably produced according to a production method that includes a step in which a fluid composition of a proton-conducting polymer dissolved or dispersed in a solvent (hereinafter also referred to as “polymer solution”) is impregnated in the sheet. A means such as vibration with ultrasonic waves or defoaming under reduced pressure can be adopted in order to cause the polymer solution to better penetrate the holes (openings) of the sheet. Thereafter, volatile constituent such as the solvent is removed from the composition to form the desired electrolyte membrane.

Another suitable method for manufacturing the electrolyte membrane includes the preparation in advance of a fluid composition in which one or two or more monomers used for polymerization to form specified proton-conducting polymer are dissolved or dispersed in a solvent; the impregnation of the fluid composition in an inorganic fiber sheet; the polymerization in this state of the monomer or monomers contained in the composition, and the removal of the solvent from the component. The composition is preferably constituted by including a monomer with an ion-exchange group or a precursor thereof (functional group). Typical examples of such a monomer are sodium allyl sulfonate, sodium methallyl sulfonate, sodium paratoluene sulfonate, and acrylic acid. A portion of the proton-conducting polymer or precursor thereof formed through polymerization (e.g., an edge of the polymer chain) can be chemically bonded to the sheet (e.g., through graft polymerization to the surface of the inorganic fiber). An electrolyte membrane comprising such a polymer matrix takes on a particularly high heat resistance.

The electrolyte membrane of the invention is well suited as a component of a PEFC. The electrode (anode and/or cathode) that constitutes such a PEFC can be a known one. A representative example of such an electrode comprises a conductive, porous support and a catalyst.

The conductive, porous support is a base with electrical conductivity and is permeable to fuels. The conductive, porous support is preferably constituted from a material not readily susceptible to corrosion by other cell element materials (e.g., electrolytic solution, electrolyte, cell-reacting fuel, cell reaction product). As fuel cells are often used at high temperatures in order to increase their reaction efficiency, materials of high heat resistance are preferable as the constituting materials of the conductive, porous support. Conductive, porous carbon is preferably used as a conductive, porous support that fulfills these conditions. Examples of such conductive, porous carbon are a woven cloth or non-woven cloth (e.g., carbon paper) comprising carbon fiber, a porous material formed by baking a mixture of carbon fiber and an organic binder, a porous material formed by baking a mixture of carbon particles and an organic binder, and a porous material formed by baking self-sintering carbon particles. The use of carbon paper or another carbon-fiber material is particularly preferable.

One example of a conductive, porous support preferably used in the invention is conductive, porous carbon formed by baking self-sintering carbon particles. One typical example of self-sintering carbon particles is mesophase microspheres (mesocarbon microbeads) obtained by heat-treating heavy oil or another such substance. Such self-sintering carbon particles can be made into a sintered product of high durability by molding and baking them alone without the use of a thermoplastic resin or other organic binder.

A known catalyst used in the field of PEFC can be used as the catalyst used in the electrode (anode and/or cathode). For example, a catalyst comprising a precious metal (preferably a platinum-group metal), an alloy of a precious metal and another precious metal, or an alloy of at least one of these precious metals and at least one transition metal (e.g., copper, chrome, ruthenium, cobalt) can be used. Of these, a catalyst comprising platinum or an alloy mainly of platinum (e.g., an alloy of platinum and another precious metal (e.g., ruthenium, palladium) is preferable. In a typical configuration of the electrode, the catalyst is held (supported) by the conductive, porous support. The catalyst can be held toward unequally on one surface of the electrolyte membrane or be held evenly distributed over the entire conductive, porous support.

In addition, a proton-conducting polymer is preferably included in the electrode. An electrode of this configuration can be made, for example, by attaching a mixture of the catalyst and the proton-conducting polymer through coating or another applying method to the conductive, porous support.

A fuel cell comprising the electrolyte membrane of the invention can be suitably used as a direct methanol fuel cell (DMFC). The methanol used as the fuel can be supplied in a liquid state or a gaseous state (methanol gas) to the anode. If the methanol is to be supplied in a liquid state, it is preferably supplied as an aqueous solution with a methanol concentration of about 0.1 to 5 moles per liter (more preferably, about 0.5 to 2 moles per liter).

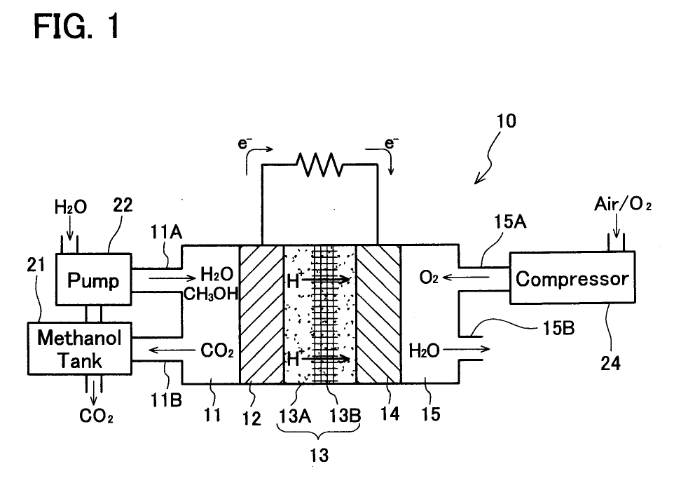

One embodiment of the invention preferably applied in a DMFC is shown schematically in FIG. 1. A direct methanol fuel cell 10 is typically constructed by sandwiching an electrolyte membrane 13 between an anode 12 and a cathode 14. The electrolyte membrane 13 comprises a proton-conducting polymer matrix 13A composed primarily of a proton-conducting polymer (e.g., a perfluorocarbon sulfonic acid resin) and a sheet 13B (e.g., glass cloth) composed primarily of an inorganic fiber (e.g., glass fiber). Preferably, the thickness of the sheet 13B is less than the thickness of the polymer matrix 13A and almost all of the thickness of the sheet 13B is lodged (embedded) in the polymer matrix 13A, as is shown in the figure. The portion of the electrolyte membrane 13 touching the anode 12 and the cathode 14 (i.e., the surface of the electrolyte membrane 13) is substantially constituted of the polymer matrix 13A. The anode 12 and the cathode 14 each hold in conductive, porous carbon a catalyst capable of generating hydrogen from methanol (e.g., a platinum-ruthenium catalyst) and a proton-conducting polymer (e.g., a perfluorocarbon sulfonic acid resin). And at the time of use, a cell with this construction is heated to a specified operating temperature (e.g., 80° C. to 120° C.).

A fuel chamber 11 is formed on the rear surface of the anode 12 (the side opposite the electrolyte membrane 13). A pump 22 is connected via a pipe (inlet) 11A to the fuel chamber 11. A methanol tank 21 and a water resource (water route) not shown are connected to the pump 22, and methanol as a fuel and water (an aqueous solution of methanol) can be supplied to the fuel chamber 11. The methanol supplied to the fuel chamber 11 is preferably adjusted to about the same temperature as the specified operating temperature. The carbon dioxide generated at the anode 12 is sent through a pipe (outlet) 11B together with excess methanol and water to the methanol tank 21. The recovered methanol and water are again supplied by the pump 22, while the carbon dioxide is released to the outside.

A compressor 24 is connected via a pipe (inlet) 15A to a gas chamber 15 formed on the rear surface of the cathode 14. The operation of the compressor 24 supplies oxygen gas or a oxygen-comprising gas (e.g., air) to the gas chamber 15. The water generated at the cathode 14 passes through a pipe (outlet) 15B together with excess oxygen (air) and is released to the outside.

The electrolyte membrane and fuel cell elements disclosed herein can be used to construct a PEFC of the type in which hydrogen is supplied to the anode. For example, a reformer (not shown) for generating hydrogen from a fuel such as methanol could be situated on the upstream side of the pipe 11A and used as a fuel cell of a type in which the generated hydrogen from the reformer is supplied to the anode 12.

The operating temperature of a fuel cell comprising the electrolyte membrane of the invention normally is approximately 60° C. or greater (typically, approximately 60° C. to 150° C.), is preferably set to approximately 80° C. or greater (typically, approximately 80° C. to 150° C.), and is more preferably set to approximately 80° C. to 120° C. The sheet used in the invention has excellent heat resistance due to it being primarily composed of an inorganic fiber. Situating the sheet in the proton-conducting polymer matrix allows the construction of the polymer matrix (e.g., the polymer construction) to be easily maintained even under high temperatures. Therefore, the heat resistance of the proton-conducting polymer matrix can be made better in comparison to a conventional electrolyte membrane lacking an inorganic fiber sheet.

In addition, an increase in the operating temperature generally tends to make the electrolyte membrane (the proton-conducting polymer matrix) more permeable to the fuel, but the electrolyte membrane disclosed herein exhibits excellent resistance to fuel permeation (typically, resistance to methanol crossover) even when operated at relatively high temperatures. In a typical embodiment of the invention, the electrolyte membrane can be suitably used as a DMFC or other fuel cell within the temperature range of up to at least about 120° C. (up to about 150° C. in a more preferably embodiment).

### EXAMPLES

### Working Example 1

### Preparation of an Electrolyte Membrane Comprising Glass Cloth

An alcoholic solution of perfluorocarbon sulfonic acid resin sold as Nafion® Solution by Aldrich Chemical Company, Inc. (resin concentration: about 5% by mass; hereinafter also referred to as the “polymer solution”) was prepared as an ingredient of the proton-conducting polymer matrix. Moreover, glass cloth (a product of woven glass yarn (plain weave) with a fiber width of about 100 μm; opening: about 200 μm; number of glass yarn: 75 per mm warp and 75 per mm weft; weight: about 16.7 g/m²) was cut into a circle with a diameter of approximately 85 mm to prepare the sheet.

About 2 g of the polymer solution was placed in a Teflon® Petri dish (with a diameter of 90 mm) and dried under reduced pressure (at about 0.06 to 0.08 mPa below atmospheric pressure) for 10 minutes at room temperature. Then, the sheet was placed in the Petri dish, and another about 2 g of the polymer solution was added. At this time, the amount of the polymer solution used was adjusted so that the total amount of perfluorocarbon sulfonic acid resin in the Petri dish would be 0.06 to 0.1 g/cm². Ultrasonic wave oscillation was applied for three minutes so that the polymer solution would better impregnate the sheet, then drying under reduced pressure was applied (at about 0.1 mPa below atmospheric pressure) for 30 minutes at 80° C., and heat was applied for 10 minutes and 150° C. under humidity of 100%. An electrolyte membrane comprising glass cloth was prepared in this manner.

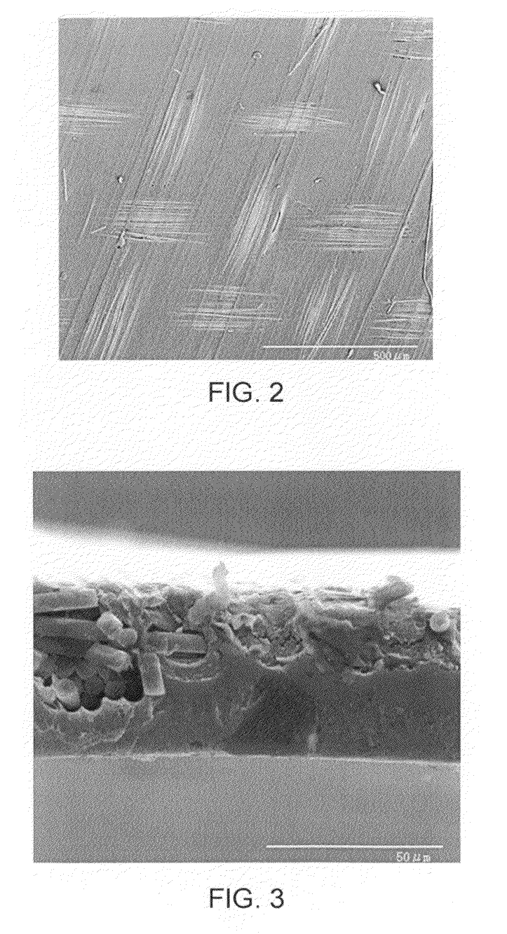

Scanning electron micrographs of the electrolyte membrane, thus prepared (Working Example 1), are shown in FIGS. 2 and 3. FIG. 2 shows the surface of the electrolyte membrane, and FIG. 3 shows a cross section thereof. As can be understood from the micrographs, a glass cloth is embedded in the proton-conducting polymer matrix (a layer comprising a perfluorocarbon sulfonic acid resin) of the electrolyte membrane of Working Example 1, and the openings of the glass cloth are filled substantially by the proton-conducting polymer. The mean thickness of the electrolyte membrane of Working Example 1 (approximately equivalent to the thickness of the proton-conducting polymer matrix) was about 60 μm.

### Comparative Example 1

### Preparation of an Electrolyte Membrane Lacking a Glass Cloth

Using the above polymer solution, an electrolyte membrane (Comparative Example 1) was prepared under a process similar to the preparation of the electrolyte membrane of Working Example 1 except that the sheet (glass cloth) was not used. Thus, the electrolyte membrane of Comparative Example 1 was constituted primarily of the perfluorocarbon sulfonic acid resin. Here, the amount of the polymer solution used was adjusted so that the thickness of the obtained electrolyte membrane (i.e., the thickness of the proton-conducting polymer matrix) would be about 60 μm.

Experiment 1: Performance Assessment of Fuel Cells with Methanol Fuel Used

A polymer electrolyte fuel cell (single cell) was prepared from each of the electrolyte membrane of Working Example 1 and the electrolyte membrane of Comparative Example 1, and the performance thereof was assessed.

Specifically, the electrodes were prepared in the following manner used for an anode and a cathode. In further detail, 1.2 g of catalyst particles with a platinum-ruthenium alloy catalyst supported on carbon microparticles (product code TEC61E54 by Tanaka Kikinzoku Kogyo K. K. was used) was immersed in 3 g of distilled water, and the mixture was dispersed in 11.5 g of the polymer solution (an alcoholic solution of perfluorocarbon sulfonic acid resin) to prepare a catalyst-dispersed solution. Then, 0.44 g of the catalyst-dispersed solution were applied to a surface of carbon paper (product code TGP-H-060 carbon paper for fuel cells by Toray; thickness: about 190 μm) with a diameter of about 35 mm (about 10 cm²) and dried at room temperature for 24 hours. An electrode in which a catalyst and proton-conducting polymer were supported on carbon paper (a conductive, porous support) was prepared in this manner.

Between two of these catalyst-containing electrodes was sandwiched an electrolyte membrane of the same size, the periphery thereof was surrounded with Teflon® sealant (thickness: about 300 μm), and this was incorporated into a cell for assessment (for 25 cm² measurements by Electrochem; procured through Toyo Technica). Measurements of the current density-voltage characteristics of the single cell constituted in this manner were taken under the conditions noted below using a fuel cell assessment system obtainable from Toyo Technica (the 890B fuel cell assessment system by Scribner of the United States). An aqueous solution of methanol with a methanol concentration of 1 mole per liter was used as the fuel supplied to the anode.

Generating Conditions:

Cell temperature: 95° C., Pipe temperature: 95° C., Humidification temperature: 95° C.
Fuel (the aqueous solution of methanol) flow rate: 3 mL/minute
Flow rate of gas (O₂) supplied to cathode: 250 mL/minute

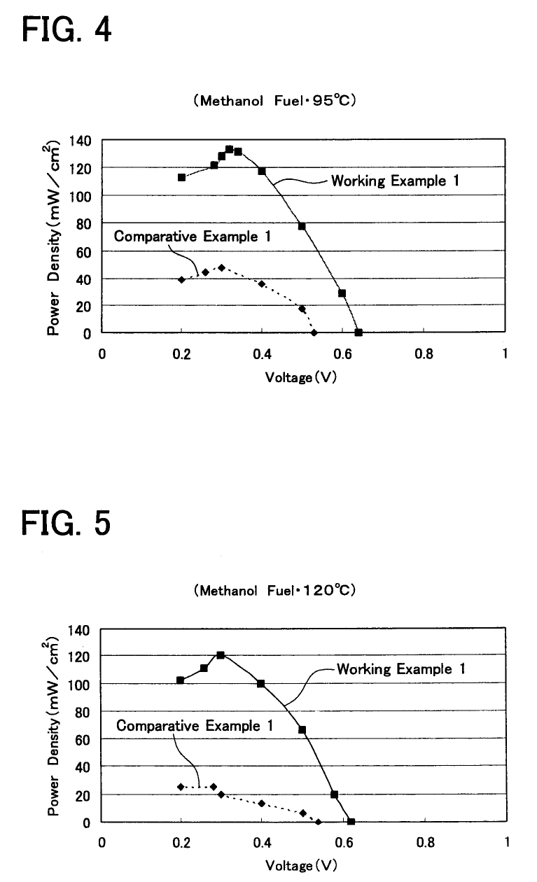

Measurements of the current density-voltage characteristics for the fuel cell constituted with the electrolyte membrane of Working Example 1 (hereinafter referred to as the “fuel cell of Working Example 1”) are presented in Table 1, and those of the fuel cell constituted with the electrolyte membrane of Comparative Example 1 (hereinafter referred to as the “fuel cell of Comparative Example 1”) are presented in Table 2. The power densities of the fuel cells were calculated from these measurements. The results are presented in FIG. 4.

TABLE 1
Working Example 1

| | Current density |
|---|---|
| Voltage (V) | (mA/cm²) |
| 0.64 | 0 |
| 0.6 | 48.1 |
| 0.5 | 156 |
| 0.4 | 294 |
| 0.34 | 328 |
| 0.32 | 392 |
| 0.3 | 399 |
| 0.28 | 407 |
| 0.2 | 405 |

(Methanol fuel, 95° C.)

TABLE 2
Comparative Example 1

| | Current density |
|---|---|
| Voltage (V) | (mA/cm²) |
| 0.53 | 0 |
| 0.5 | 35.6 |
| 0.4 | 89.9 |
| 0.3 | 159 |
| 0.26 | 171 |
| 0.2 | 194 |

(Methanol fuel, 95° C.)

As FIG. 4 clearly illustrates, the fuel cell of Working Example 1—which comprises an electrolyte membrane with a glass cloth embedded in a proton-conducting polymer matrix—achieved a power density much higher than that of the fuel cell of Comparative Example 1 (approximately 2 to 3 times greater). In the voltage range of about 0.25 to 0.4 V, for example, a high power density of about at least 120 mW/cm² was achieved. And in the voltage range of about 0.3 to 0.35 V, for example, an even higher power density of about at least 130 mW/cm² was achieved. Such power density levels were maintained in a stable manner for about at least an hour.

Experiment 2: Performance Assessment of Fuel Cells with Methanol Fuel Used (at High Temperature)

Using the aqueous methanol solution of Experiment 1 (with a methanol concentration of 1 mole per liter), the current density-voltage characteristics of the fuel cell of Working Example 1 and the fuel cell of Comparative Example 1 were measured under a process similar to that of Experiment 1 except that the cell, pipe, and humidification temperatures were changed to 120° C., respectively. The measurements for the fuel cell of Working Example 1 are shown in Table 3, and those for the fuel cell of Comparative Example 1 are shown in Table 4. The power densities of the fuel cells were calculated from these measurements. The results are presented in FIG. 5.

TABLE 3
Working Example 1

| | Current density |
|---|---|
| Voltage (V) | (mA/cm²) |
| 0.62 | 0 |
| 0.58 | 34.5 |
| 0.5 | 133 |
| 0.4 | 250 |
| 0.3 | 300 |
| 0.26 | 370 |
| 0.2 | 393 |

(Methanol fuel, 120° C.)

TABLE 4
Comparative Example 1

| | Current density |
|---|---|
| Voltage (V) | (mA/cm²) |
| 0.54 | 0 |
| 0.5 | 13.3 |
| 0.4 | 33.3 |
| 0.3 | 66.7 |
| 0.28 | 85.2 |
| 0.2 | 91.3 |

(Methanol fuel, 120° C.)

As FIG. 5 clearly illustrates, the fuel cell of Working Example 1 achieved a power density much higher than that of the fuel cell of Comparative Example 1. In the voltage range of about 0.2 to 0.4 V, for example, a high power density of about at least 100 mW/cm² was achieved. And in the voltage range of about 0.25 to 0.35 V, for example, an even higher power density of about at least 110 mW/cm² was achieved. Such power density levels were maintained in a stable manner for about at least an hour. A comparison with the results shown in FIG. 4 clearly reveals that the power density of the fuel cell of Comparative Example 1 was appreciably lower at 120° C. than at 95° C., but there was a low drop in power density for the fuel cell of Working Example 1 even when the operating temperature was increased. This indicates that the electrolyte membrane of Working Example 1 has greater heat resistance than the electrolyte membrane of Comparative Example 1.

Experiment 3: Performance Assessment of Fuel Cells with Hydrogen Fuel Used

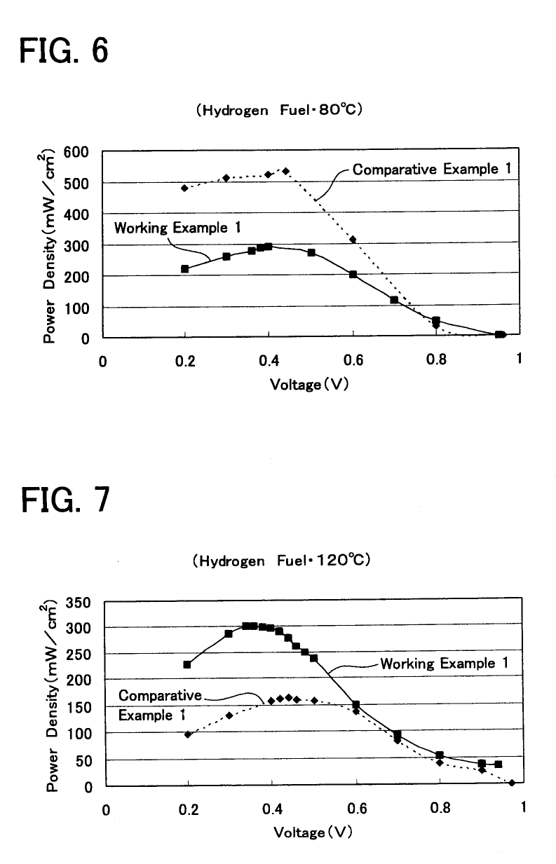

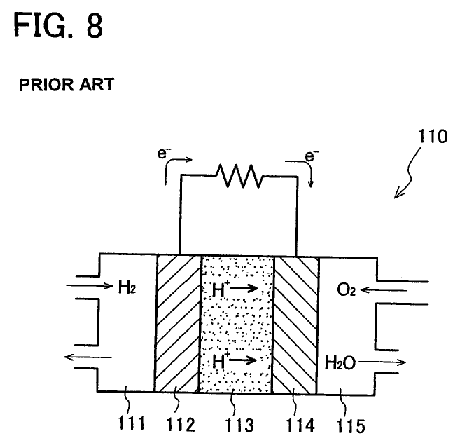

A fuel cell (single cell) was constituted from each of the electrolyte membrane of Working Example 1 and the electrolyte membrane of Comparative Example 1 under the above process. Hydrogen was supplied to the anode in place of the aqueous methanol solution, and the current density-voltage characteristics of the fuel cell of Working Example 1 and the fuel cell of Comparative Example 1 were measured under a process similar to that of Experiments 1 and 2 according to the generation conditions below. The measurements for the fuel cell of Working Example 1 are listed in Table 5, and those for the fuel cell of Comparative Example 1 are listed in Table 6. The power densities of the fuel cells were calculated from these measurements. The results are presented in FIG. 6.

Generating Conditions:

Cell temperature: 80° C., Pipe temperature: 80° C., Humidification temperature: 80° C.
Fuel (H₂) flow rate: 250 mL/minute
Flow rate of gas (O₂) supplied to cathode: 250 mL/minute

TABLE 5
Working Example 1

| | Current density |
|---|---|
| Voltage (V) | (mA/cm²) |
| 0.95 | 0 |
| 0.8 | 61.1 |
| 0.7 | 167 |
| 0.6 | 333 |
| 0.5 | 540 |
| 0.4 | 731 |
| 0.38 | 751 |
| 0.36 | 772 |
| 0.3 | 859 |
| 0.2 | 1100 |

(Hydrogen fuel, 80° C.)

TABLE 6
Comparative Example 1

| | Current density |
|---|---|
| Voltage (V) | (mA/cm²) |
| 0.96 | 0 |
| 0.8 | 37.5 |
| 0.6 | 524 |
| 0.44 | 1212 |
| 0.4 | 1311 |
| 0.3 | 1711 |
| 0.2 | 2400 |

(Hydrogen fuel, 80° C.)

Experiment 4: Performance Assessment of Fuel Cells with Hydrogen Fuel Used (at High Temperature)

The current density-voltage characteristics of the fuel cell of Working Example 1 and the fuel cell of Comparative Example 1 were measured similarly to Experiment 3 with hydrogen supplied to the anode except that the cell, pipe, and humidification temperatures were changed to 120° C., respectively. The measurements for the fuel cell of Working Example 1 are shown in Table 7, and those for the fuel cell of Comparative Example 1 are shown in Table 8. The power densities of the fuel cells were calculated from these measurements. The results are presented in FIG. 7.

TABLE 7
Working Example 1

| | Current density |
|---|---|
| Voltage (V) | (mA/cm²) |
| 0.94 | 37.8 |
| 0.9 | 40.7 |
| 0.8 | 66.7 |
| 0.7 | 130 |
| 0.6 | 248 |
| 0.5 | 473 |
| 0.48 | 521 |
| 0.46 | 572 |
| 0.44 | 631 |
| 0.42 | 690 |
| 0.4 | 742 |
| 0.38 | 787 |
| 0.36 | 836 |
| 0.34 | 882 |
| 0.3 | 956 |
| 0.2 | 1133 |

(Hydrogen fuel, 120° C.)

TABLE 8
Comparative Example 1

| | Current density |
|---|---|
| Voltage (V) | (mA/cm²) |
| 0.97 | 0 |
| 0.9 | 27.2 |
| 0.8 | 48.6 |
| 0.7 | 116 |
| 0.6 | 228 |
| 0.5 | 313 |
| 0.46 | 345 |
| 0.44 | 371 |
| 0.42 | 384 |
| 0.4 | 394 |
| 0.3 | 433 |
| 0.2 | 483 |

(Hydrogen fuel, 120° C.)

As can be seen from FIGS. 6 and 7, the power density of the fuel cell of Comparative Example 1 was higher in most of the range measured at 80° C. (FIG. 6). On the other hand, at 120° C. (FIG. 7), the power density of the fuel cell of Working Example 1 was higher over the entire range measured. As the proton-conducting polymer matrix is supported by the sheet, the heat resistance was more satisfactory than that of the electrolyte membrane of Comparative Example 1. A fuel cell with such a highly heat resistant electrolyte membrane can be used at a relatively high temperature, and a fuel cell system with high electrode reactivity efficiency can be obtained. No degradation of the proton-conducting polymer matrix was observed in the electrolyte membrane of Working Example 1 even under use at 120° C. (Experiments 2 and 4).

Experiment 5: Assessment of Methanol Crossover Suppression Performance

The methanol crossover prevention performance at 95° C. was assessed of the electrolyte membrane of Working Example 1, the electrolyte membrane of Comparative Example 1, and commercially available Nafion®117 Membrane (mean membrane thickness of about 175 μm) (hereinafter referred to as “electrolyte membrane of Comparative Example 2”). In greater detail, these electrolyte membranes were each used to prepare fuel cells (single cells) under a process similar to that of Experiment 1 above. Gas emitted from the cathode side was collected when the cells were run (operated) under conditions similar to those of Experiment 1 above. The emitted gas was analyzed with gas chromatography, and the concentration of methanol in the gas (i.e., the concentration of methanol permeating from the anode side) was determined. The results are presented in Table 9.

TABLE 9

| | | | Concentration of |
|---|---|---|---|
| | Thickness | Glass | permeating methanol |
| | (μm) | cloth | (% volume) |
| Working Example 1 | 60 | Present | 1.56 |
| Comparative Example 1 | 60 | Absent | 22.11 |
| Comparative Example 2 | 175 | Absent | 7.37 |

As a comparison of the electrolyte membrane of Comparative Example 1 (membrane thickness of about 60 μm) and the electrolyte membrane of Comparative Example 2 (membrane thickness of about 175 μm) clearly shows, methanol permeation prevention performance drops appreciably as the electrolyte membrane (proton-conducting polymer matrix) grows thinner. In contrast, the electrolyte membrane of Working Example 1—a glass cloth embedded in a proton-conducting polymer matrix—exhibited a methanol permeation prevention performance in excess of that of the electrolyte membrane of Comparative Example 2 (membrane thickness of about 175 μm) despite having a thickness of about that of the electrolyte membrane of Comparative Example 1 (membrane thickness of about 60 μm).

### Working Example 2

### Preparation of an Electrolyte Membrane Comprising Glass Cloth

A glass cloth (a product of woven glass yarn (plain weave) with a fiber width of about 100 μm; opening: about 140 μm; number of glass yarn: 70 per mm warp and 70 per mm weft; weight: about 12 g/m²) was cut into a circle with a diameter of approximately 85 mm to prepare the sheet.

Using about 4 g (2 g+2 g) of the above polymer solution and the above sheet, an electrolyte membrane (Working Example 2) was prepared under a process similar to the preparation of the electrolyte membrane of Working Example 1.

### Comparative Example 3

### Preparation of an Electrolyte Membrane

About 0.135 g of a fumed silica powder obtainable from Aldrich Chemical Company, Inc. was dispersed in 4.5 g of the above polymer solution. Using the dispersion, an electrolyte membrane (Comparative Example 3) was prepared under a process similar to the preparation of the electrolyte membrane of Working Example 1 except that the glass cloth was not used.

### Comparative Example 4

### Preparation of an Electrolyte Membrane

A honeycomb ceramic filter with 6 mm cell size (Alumina filter for micro filtration (MF), thickness: 200 μm, porosity: 42%, pore size: 10 μm) obtainable from Noritake Co., Limited was cut into a circle with a diameter of approximately 85 mm. Using the filter and about 15 g of the above polymer solution, an electrolyte membrane (Comparative Example 4) was prepared under a process similar to the preparation of the electrolyte membrane of Working Example 1 except that the glass cloth was not used.

### Comparative Example 5

### Preparation of an Electrolyte Membrane

A 20 g of zeolite (A4) powder obtainable from Tosoh Corporation, 60 g of methanol and 20 g of water were kneaded with 3 μm diameter alumina balls for about 24 hours. The zeolite powder was mixed with the above polymer solution such that zeolite content would be about 30 vol %, and ultrasonic wave oscillation was applied for five minutes so that the zeolite powder would be dispersed better. Using the mixture, an electrolyte membrane (Comparative Example 5) was prepared under a process similar to the preparation of the electrolyte membrane of Working Example 1 except that the glass cloth was not used.

Experiment 6: Performance Assessment of Fuel Cells with Methanol Fuel Used

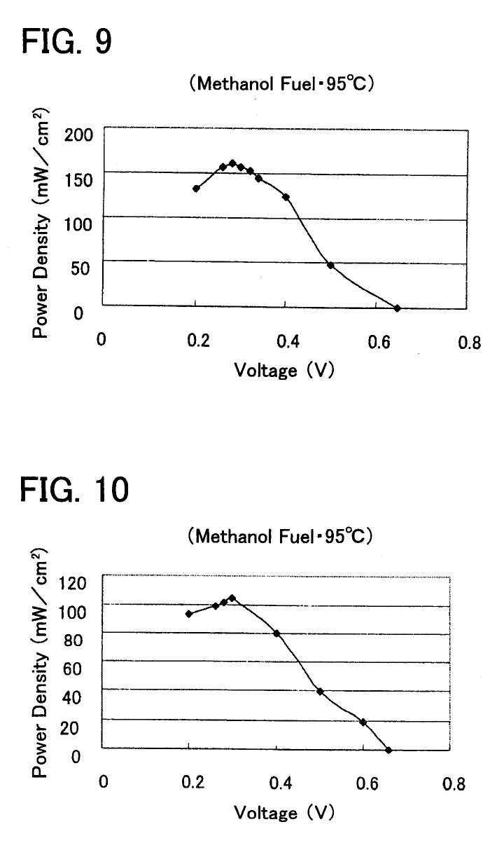

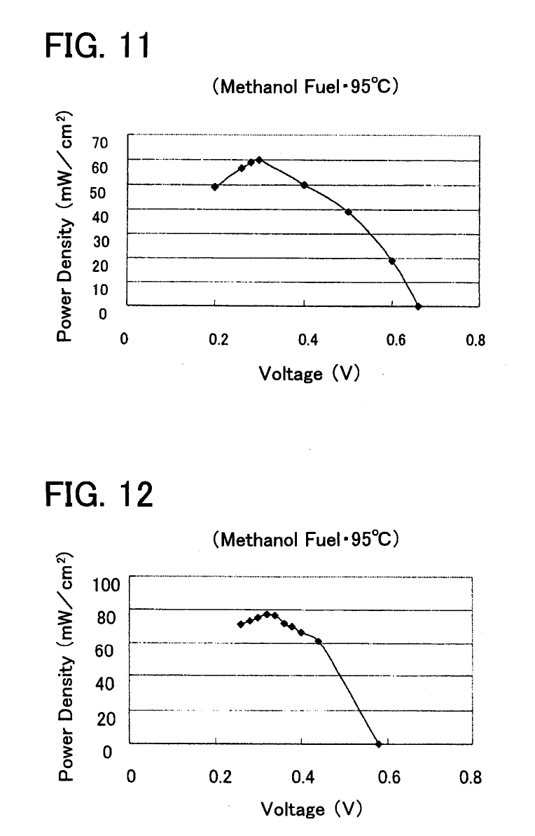

A polymer electrolyte fuel cell (single cell) was prepared from each of the electrolyte membrane of Working Example 2 and the electrolyte membranes of Comparative Examples 3-5. The aqueous methanol solution of Experiment 1 was supplied to the anode, and the current density-voltage characteristics of those cells were assessed under a process similar to the Experiment 1. The power densities of the fuel cells were calculated from these measurements. The results are presented in Tables 10-13 and FIGS. 9-12.

TABLE 10
Working Example 2

| | Power density |
|---|---|
| Voltage (V) | (mW/cm²) |
| 0.65 | 0 |
| 0.5 | 48 |
| 0.4 | 124 |
| 0.34 | 144 |
| 0.32 | 152 |
| 0.3 | 156 |
| 0.28 | 160 |
| 0.26 | 156 |
| 0.2 | 132 |

(Methanol fuel, 95° C.)

TABLE 11
Comparative Example 3

| | Power density |
|---|---|
| Voltage (V) | (mW/cm²) |
| 0.66 | 0 |
| 0.6 | 19 |
| 0.5 | 39 |
| 0.4 | 80 |
| 0.3 | 104 |
| 0.28 | 101 |
| 0.26 | 99 |
| 0.2 | 93 |

(Methanol fuel, 95° C.)

TABLE 12
Comparative Example 4

| | Power density |
|---|---|
| Voltage (V) | (mW/cm²) |
| 0.66 | 0 |
| 0.6 | 19 |
| 0.5 | 39 |
| 0.4 | 50 |
| 0.3 | 60 |
| 0.28 | 59 |
| 0.26 | 57 |
| 0.2 | 49 |

(Methanol fuel, 95° C.)

TABLE 13
Comparative Example 5

| | Power density |
|---|---|
| Voltage (V) | (mW/cm²) |
| 0.58 | 0 |
| 0.44 | 61 |
| 0.4 | 67 |
| 0.38 | 70 |
| 0.36 | 72 |
| 0.34 | 77 |
| 0.32 | 78 |
| 0.3 | 76 |
| 0.28 | 73 |
| 0.26 | 71 |

(Methanol fuel, 95° C.)

Experiment 7: Performance Assessment of Fuel Cells with Hydrogen Fuel Used

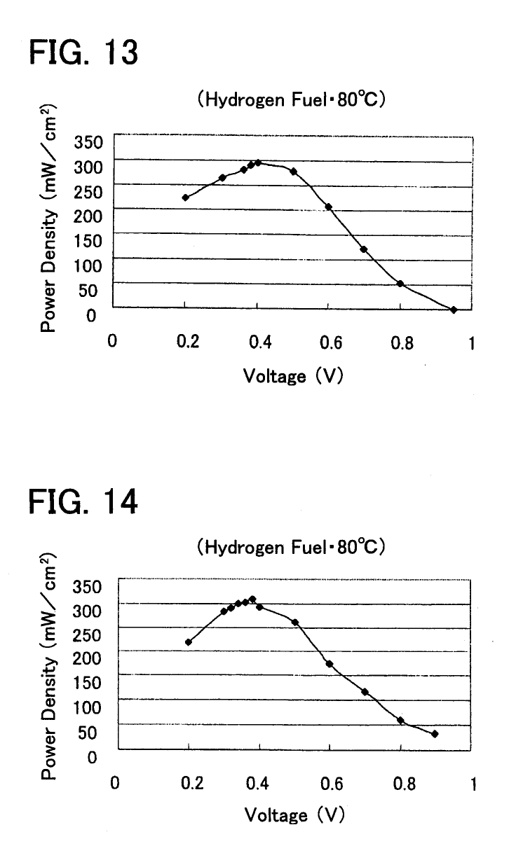

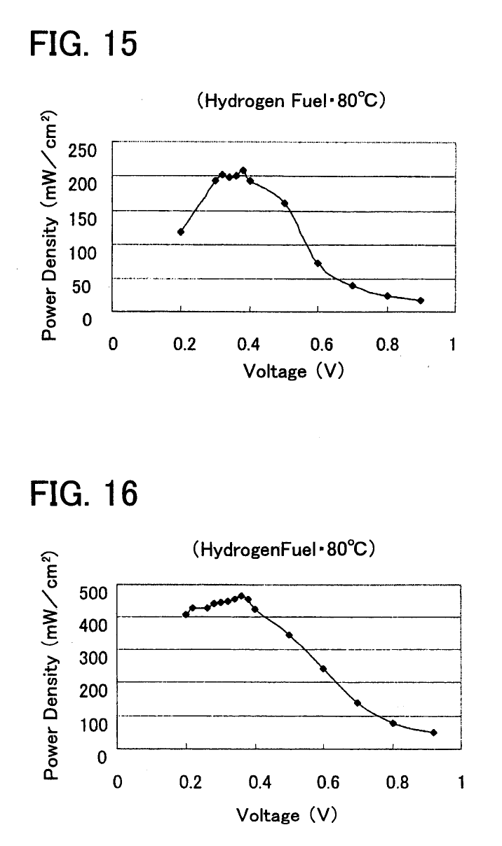

Hydrogen was supplied to the anode, and the current density-voltage characteristics of the fuel cell of Working Example 2 and the fuel cells of Comparative Examples 3-5 were measured under a process similar to that of Experiment 3. The power densities of the fuel cells were calculated from these measurements. The results are presented in Tables 14-17 and FIGS. 13-16.

TABLE 14
Working Example 2

| | Power density |
|---|---|
| Voltage (V) | (mW/cm²) |
| 0.95 | 0 |
| 0.8 | 53 |
| 0.7 | 122 |
| 0.6 | 207 |
| 0.5 | 278 |
| 0.4 | 296 |
| 0.38 | 291 |
| 0.36 | 281 |
| 0.3 | 264 |
| 0.2 | 224 |

(Hydrogen fuel, 80° C.)

TABLE 15
Comparative Example 3

| | Power density |
|---|---|
| Voltage (V) | (mW/cm²) |
| 0.9 | 32 |
| 0.8 | 59 |
| 0.7 | 116 |
| 0.6 | 173 |
| 0.5 | 261 |
| 0.4 | 293 |
| 0.38 | 310 |
| 0.36 | 302 |
| 0.34 | 299 |
| 0.32 | 291 |
| 0.3 | 283 |
| 0.2 | 219 |

(Hydrogen fuel, 80° C.)

TABLE 16
Comparative Example 4

| | Power density |
|---|---|
| Voltage (V) | (mW/cm²) |
| 0.9 | 17 |
| 0.8 | 24 |
| 0.7 | 39 |
| 0.6 | 73 |
| 0.5 | 161 |
| 0.4 | 193 |
| 0.38 | 210 |
| 0.36 | 200 |
| 0.34 | 199 |
| 0.32 | 202 |
| 0.3 | 194 |
| 0.2 | 119 |

(Hydrogen fuel, 80° C.)

TABLE 17
Comparative Example 5

| | Power density |
|---|---|
| Voltage (V) | (mW/cm²) |
| 0.92 | 51 |
| 0.8 | 78 |
| 0.7 | 140 |
| 0.6 | 242 |
| 0.5 | 346 |
| 0.4 | 427 |
| 0.38 | 456 |
| 0.36 | 467 |
| 0.34 | 456 |
| 0.32 | 448 |
| 0.3 | 444 |
| 0.28 | 441 |
| 0.26 | 429 |
| 0.22 | 428 |
| 0.2 | 408 |

(Hydrogen fuel, 80° C.)

Experiment 8: Durability Assessment of Fuel Cells with Methanol Fuel Used

Three fuel cells (Samples 1-3) were constituted from the electrolyte membranes of Working Example 2 under the above process, and the open-circuit voltage of those cells were measured. Then the cells were used for 1000 hours under the condition similar to the generating conditions of Experiment 1. After 1000 hours usage, the open-circuit voltage of those cells were measured. The results are listed in Table 18. As shown in Table 18, the open-circuit voltage of the cells measured after 1000 hours usage almost remained unchanged. It indicates that no breakage of the membrane had occurred; i.e. the electrolyte membrane of Working Example 2 has the durability of at least 1000 hours.

TABLE 18

open-circuit
voltage (V)

| | before | after |
|---|---|---|
| Sample 1 | 0.63 | 0.62 |
| Sample 2 | 0.65 | 0.63 |
| Sample 3 | 0.66 | 0.66 |

A specific example of the invention was discussed herein in detail, but this is no more than an example and does not limit the scope of the claims. A variety of different configurations and modifications of the specific example presented above are included in the technology recited in the scope of the claims.

In addition, the technical elements discussed in the Specification or drawings demonstrate technical utility independently or in any combination and are not limited to the combinations recited in the claims at the time of filing. Moreover, the technologies presented as examples in the Specification or drawings simultaneously achieve a plurality of objects and have technical utility by achieving any one of those objects.

What is claimed is:

1. A method for producing an electrolyte membrane which is intended for use in a fuel cell, comprising:
obtaining a sheet substantially consisting of an inorganic fiber;
obtaining a fluid composition comprising a proton-conducting polymer dissolved or dispersed in a solvent;
impregnating the fluid composition into the sheet; and
removing the solvent from the composition.

2. A method for producing an electrolyte membrane which is intended for use in a fuel cell, comprising:
obtaining a sheet substantially consisting of an inorganic fiber;
obtaining a fluid composition comprising one or two or more monomers capable of polymerizing to form a proton-conducting polymer;
impregnating the fluid composition into the sheet;
polymerizing the monomer or monomers contained in the composition; and
removing the solvent from the composition.
